(19) United States
(12) Patent Application Publication
(10) Pub. No.: US 2006/0140714 A1
(43) Pub. Date: Jun. 29, 2006

(54) Apparatus for connecting support bars of a sport equipment

(76) Inventor: Leao Wang, Taiping (TW)

Correspondence Address: KUO-HSIUNG CHIU, 13F., NO.23, JIUN-HO STREET, PEITUN DISTRICT, TAICHUNG, 406, TW

(21) Appl. No.: 11/024,335

(22) Filed: Dec. 29, 2004

(51) Int. Cl. F16B 1/00

(52) U.S. Cl. 403/379.3

(57) ABSTRACT

An apparatus for connecting support bars of a sport equipment, having a first bar, a second bar and means for connecting both bars. The connecting means contains two screwing nuts and a bolt. A connecting portion is formed on the head of the first bar, and a plurality of guiding pieces is disposed within the connecting portion. The screwing nuts are screwed on both ends of the bolt. Therefore, in connecting two bars, the connecting means is placed within the connecting portion such that the chamfers of the guiding pieces fit in place into the guide slots of the screwing nuts, respectively. Then, the connecting means is mounted on the connecting portion of the first bar. Thereafter, a hand tool is attached to the adjusting head of the bolt for turning the bolt so that the screwing nuts are synchronously extended outwards against the guiding pieces for a firm connection of the bars.

### BACKGROUND OF THE INVENTION

1. Fields of the Invention

The invention relates to an apparatus for connecting support bars of a sport equipment, particularly to a new practical design which can simplify the construction of connecting parts and make the assembly and disassembly faster and more convenient. Meanwhile, it can also keep the surface flatness on the area of connection.

2. Description of the Related Art

The chassis of most popular sport equipments (such as treadmill, spinner bike) consists of several connecting bars. Please refer to FIG. 5. In the fastening area of two bars 10 and 20, a connector 12 was fixed. The outer dimensions of this connector are exactly identical to the inner dimensions of the bar 20. Several fastening holes 14 are provided in the connector 12. Therefore, in connecting two bars, the first bar 10 is placed under the connector 12, which is located at one side of the second bar 20, and then the two bars will be fastened by several bolts 24 through the fastening holes 14.

Of course, this primary art of bar connection has been employed for years and it was regarded as standard without any defect. However, it brings several following disadvantages which must be taken into consideration.

1. Firstly, in order to ensure the expecting connecting strength, several bolts are employed to protect the connection from being loosened. However, to use too many fastening parts increases the difficulties in the assembly and disassembly.

2. The flatness in the connecting area is influenced to a great extent.

3. All the fastening bolts are exposed. In case of that some bolts are not firmly tightened or exposed to a large extent, it can be dangerous for people around.

4. When some bolts are lost unexpectedly, we must only use the same bolt with same dimensions and pitch; otherwise, it may lead to inconvenience in future (for example, the thread is damaged.)

### SUMMARY OF THE INVENTION

Therefore, concerning the aforementioned limitations, the inventor assumes if the hiding connection can replace the conventional exposing one, not only the same connecting function but also the full appearance and the safety in using bars will be ensured. Meanwhile, it will completely eliminate the danger which arises when the bolts are loosened or lost. The rapid assembly and disassembly are also available and it is very useful for the manufacturing and maintenance. The inner connector is placed in the connecting area of two bars; it couples with two moving parts, which can move synchronously with a bolt. Then, the rapid clamping connection through the extending and retracting action of the moving parts will be achieved. Refer to the potential advantages stemming from the improvement of the conventional connection, this design is a practical innovation. This point is just the main object of the invention.

### BRIEF DESCRIPTION OF THE DRAWINGS

The accomplishment of this and other objects of the invention will become apparent from the following description and its accompanying drawings of which:

FIG. 1 is a perspective exploded view of a first embodiment of an apparatus for connecting support bars of a sport equipment in accordance with the invention;

FIG. 2 is a top view of the first embodiment of the invention after assembly;

FIG. 3 is a top view of a second embodiment of the invention after assembly;

FIG. 4 is a top view of a third embodiment of the invention after assembly; and

FIG. 5 is a perspective exploded view of a conventional apparatus for connecting support bars of a sport equipment.

### DETAILED DESCRIPTION OF THE PREFERRED EMBODIMENT

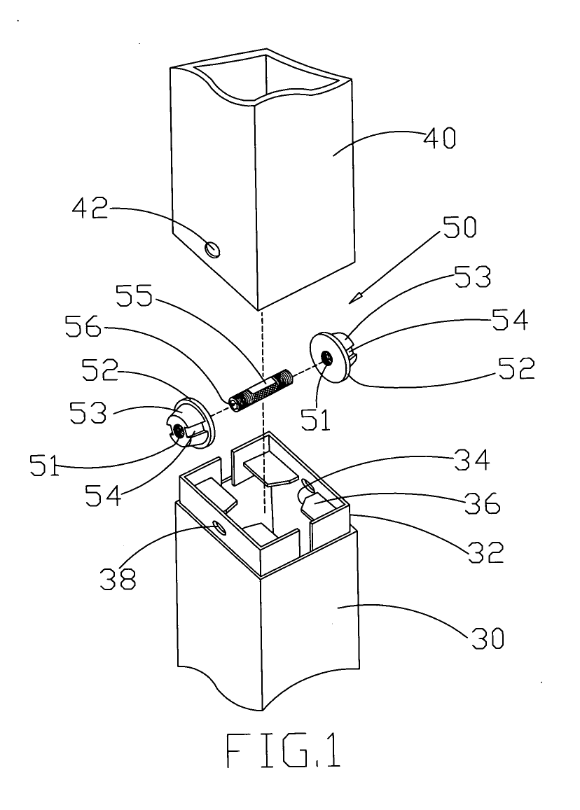

Referring to FIGS. 1 and 2, an apparatus for connecting support bars of a sport equipment in accordance with the invention includes:

a first bar 30 having a connecting portion 32 with the same external dimensions to the internal dimensions to a second bar 40, a guiding piece 36 being formed at each of four corners within the connecting portion 32, the guiding pieces 36 each having a chamfer 34, the connecting portion 32 having a through hole 38 in two nonadjacent sides thereof;

a second bar 40 having through holes 42 corresponding to the through holes 38 of the first bar 30;
means 50 for connecting the bars 30, 40, having two screwing nuts 52 with internal thread and a bolt 55 with external thread at both ends of thereof, the screwing nuts 52 being screwed on the both ends of the bolt 55, the screwing nuts 52 each having a cone-shaped body 53 tapering to the outside, the cone-shaped body 53 having a guide slot 54 at both sides thereof, the bolt 55 having an adjusting head 56.

In connecting the two bars 30, 40, the connecting means 50 is placed into the connecting portion 32 of the first bar 30 such that the chamfers 34 of the guiding pieces 36 fit in place into the guide slots 54 of the screwing nuts 52, respectively. Then, the second bar 40 is mounted on the connecting portion 32 of the first bar 30. Thereafter, a common hand tool, such as wrench, screwdriver (not illustrated in the drawing) is attached to the adjusting head 56 of the bolt 55 for turning the bolt 55 so that the screwing nuts 52 are synchronously extended outwards against the guiding pieces 36 for a firm connection of the bars 30, 40.

Of course, when disassembling, turn the bolt 55 in the opposite direction. The two screwing nuts 52 will be inwardly retracted to release the bars 30, 40.

To adjust the bolt 55, we can use the popular hand tool which has the same working head, such as screwdriver or wrench with cross, flat, inner hexagonal, outer hexagonal head etc.

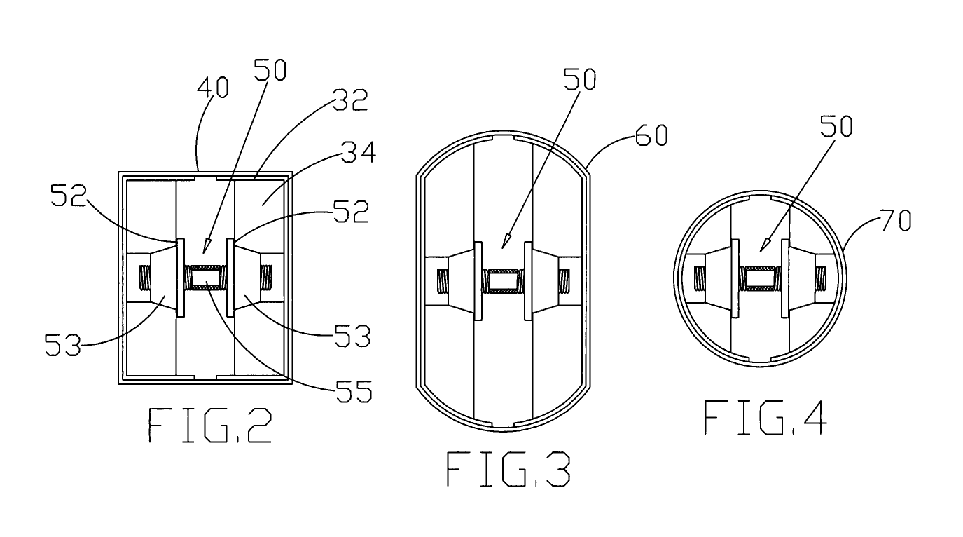

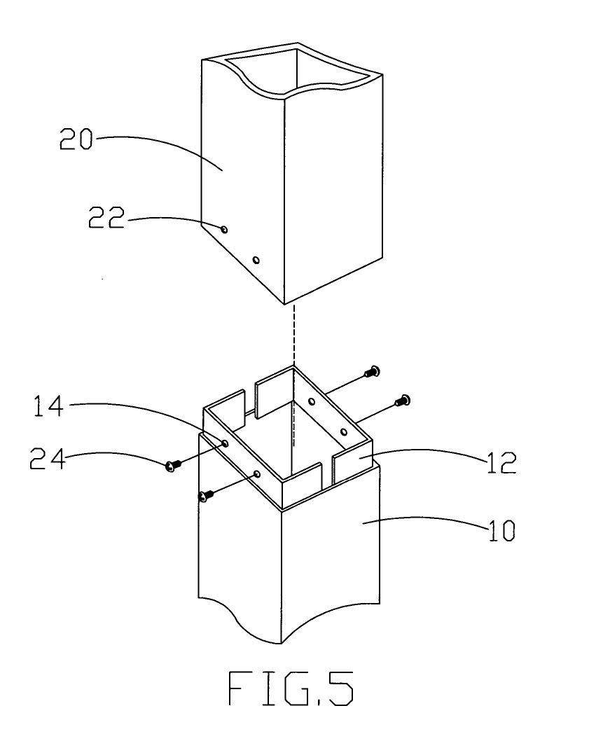

Furthermore, as shown in FIGS. 3 and 4, the means 50 for connecting oval bars 60, round bars 70, or hollow bars can be reshaped according to the principle of the invention; therefore, the invention has a wide practical application.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claim.

What is claimed is:

1. An apparatus for connecting support bars of a sport equipment, comprising:
a) a first bar having a connecting portion with the same external dimensions to the internal dimensions to a second bar, a guiding piece being formed at each of four corners within the connecting portion, the guiding pieces each having a chamfer, the connecting portion having a through hole in two nonadjacent sides thereof;
b) a second bar having through holes corresponding to the through holes of the first bar; and
c) means for connecting the bars, having two screwing nuts with internal thread and a bolt with external thread at both ends of thereof, the screwing nuts being screwed on the both ends of the bolt, the screwing nuts each having a cone-shaped body tapering to the outside, the cone-shaped body having a guide slot at both sides thereof, the bolt having an adjusting head.
